(19) United States
(12) Patent Application Publication
(10) Pub. No.: US 2011/0245366 A1
(43) Pub. Date: Oct. 6, 2011

(54) PROCESS FOR PREPARING POLYESTER ALCOHOLS AND USE THEREOF FOR PREPARATION OF POLYURETHANES

(75) Inventors: Lionel GEHRINGER, Schaffhouse-pres-Seltz (FR); Faissal-Ali El-Toufaili, Ludwigshafen (DE); Ulrike Mahn, Mannheim (DE); Christian Pilger, Ludwigshafen (DE)

(73) Assignee: BASF SE, Ludwigshafen (DE)

(21) Appl. No.: 13/075,613

(22) Filed: Mar. 30, 2011

Related U.S. Application Data
(60) Provisional application No. 61/319,913, filed on Apr. 1, 2010.

(51) Int. Cl. C08G 18/64; C08F 2/46; C08J 3/28; C08G 63/16

(52) U.S. Cl. 522/146; 522/179; 528/293; 528/272; 525/440.01

(57) ABSTRACT

The invention relates to a process for preparing polyester alcohols by catalytically reacting at least one at least difunctional carboxylic acid or a derivative thereof with at least one at least difunctional alcohol, which comprises performing at least part of the reaction in the presence of microwave radiation.

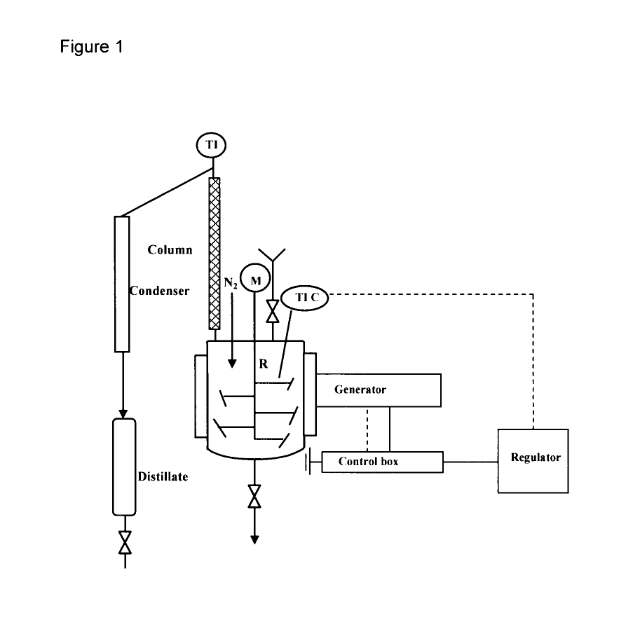

The present invention relates to a process for preparing polyester alcohols based on polyfunctional aromatic and/or aliphatic carboxylic acids or derivatives thereof and difunctional, trifunctional and/or higher-functionality alcohols, wherein the reaction is performed in the presence of microwave radiation, to polyesterol alcohols preparable by the process according to the invention, and to the use of these polyester alcohols (PESOLs) for preparation of polyurethanes.

In the context of this invention, the terms “polyester alcohol”, “polyesterol”, “polyester polyol” and the abbreviation “PESOL” are used synonymously.

### BACKGROUND

Polyester polyols are generally prepared by the reaction of dicarboxylic acids with polyols at high temperature. Further details of the industrial scale preparation of polyester polyols can be found, for example, in the Kunststoffhandbuch Polyurethane, edited by G. Oertel, 3rd ed. 1993, published by Carl Hanser, ch. 3.1.2, especially ch. 3.1.2.3.

These polyester alcohols are preferably used to prepare polyurethanes, also referred to hereinafter as PUR, especially flexible PUR foam, rigid PUR foam, rigid polyisocyanurate (PIR) foam, and also other cellular or noncellular PUR materials. The different fields of use require a specific selection of the starting materials and of the polycondensation technology to be performed. It is known that polyfunctional aromatic and/or aliphatic carboxylic acids or anhydrides thereof and difunctional, trifunctional and/or higher-functionality alcohols, especially glycols, can be used to prepare polyester alcohols. The feedstocks are usually reacted with one another at temperatures of 150-280° C. under standard pressure and/or gentle vacuum in the presence of catalysts withdrawal of the water of reaction. The customary technology is described, for example, in DE-A-2904184 and consists in the conversion of the reaction components with a suitable catalyst while simultaneous increasing the temperature and lowering the pressure. The temperatures and the reduced pressure are then altered further in the course of the synthesis. The polycondensation reactions can be performed either in the presence or in the absence of a solvent.

In general, conventional heating systems are used at the production sites for PESOLs, in order to attain and maintain the reaction temperature of approx. 150-280° C. The average production cycle time is about 5 to 24 h.

In conventional processes for preparing polyester alcohols, the reaction mixture is heated through the vessel wall (external heating, for example through the jacket). The temperature at the reactor wall is thus higher than that in the reaction mixture. This can lead to undesired decomposition and discoloration as a result of overheating, for example local overheating. In addition, in the case of external heating, release of a portion of the thermal energy to the environment cannot be prevented, which reduces the efficiency of the heating.

The use of microwaves in the chemical synthesis is known in principle. DE 3036314 describes a process for preparing condensation polymers employing microwaves, for example for production of PET, unsaturated polyester resin or nylon-6,6.

The synthesis of polyamides, polyesters and polyamide esters, e.g. nylon-6,6 or polycaprolactone, under the influence of microwaves is described in U.S. Pat. No. 6,515,040.

JP 2006169397 discloses a process for preparing aliphatic polyesters by polycondensation of aliphatic polyols and aliphatic dicarboxylic acids under microwave irradiation.

EP 1964877 and WO 2003064510 concern the glycolysis and recycling of PET. This involves depolymerizing a polyester, e.g. PET, by microwave irradiation.

WO 2007/025649 (EP 1928937) describes a process for preparing polyester polyols by transesterification under microwave radiation, wherein polyester polyols are alcoholyzed under microwave irradiation.

However, none of the processes disclosed gives a solution to the above mentioned problems in the synthesis of polyester alcohols; none of the processes described to date can afford polyester polyols with particular specifications such as OH number, acid number, etc. Specifically the acid number should generally be at a minimum in order that the polyester polyols obtained can be used advantageously for preparation of polyurethanes. The processes described to date are concerned, as already mentioned above, for example, with the preparation of polyesters.

Polyesterols are, however, a special class of polyesters. A particular feature of polyesterols is that they have a low acid number, preferably below 2. In addition, polyesterols have reactive OH groups and can thus react further, for example, to give polyurethanes.

There is therefore a need in the technical field for a process for preparing polyester alcohols with defined characteristics, which shortens the production cycle times and at the same time avoids unwanted decomposition and discoloration as a result of overheating. Moreover, the acid number of the polyester alcohol obtained should be at a minimum in order that use for preparation of polyurethanes (PU) is possible to a high degree.

It was thus an object of the present invention to provide a process for preparing polyester alcohols with defined characteristics and short cycle times, which avoids overheating and the consequences thereof, and affords products with a low acid number, and the process should be very energy-efficient.

### DESCRIPTION OF THE INVENTION

The object was achieved by a process for preparing polyester alcohols by catalytically reacting at least one at least difunctional carboxylic acid or a derivative thereof with at least one at least difunctional alcohol, which comprises performing at least part of the reaction in the presence of microwave radiation.

The preparation of polyesterols is typically a batchwise process. The synthesis proceeds through the polycondensation of dicarboxylic acids and polyfunctional alcohols.

The reaction proceeds under the action of catalysts at first under standard pressure, and later under reduced pressure. For the distillative removal of the water of reaction which arises, energy has to be supplied. When condensation sets in, the mixture is gradually heated further until approx. 90% of the water has distilled off. At the same time, the temperature at the top of the column should not rise above 100° C. since diols are otherwise also distilled off. The progress of the reaction can be checked by constantly monitoring the acid number.

It has now been found that the supply of energy or heat in the preparation of polyesterols can be effected by microwave irradiation.

In this way, it is possible to prepare polyesterols which have the desired properties such as OH number, acid number, water content, color index, and can be used, for example, for production of polyurethanes. In addition, it has been found that the supply of energy or heat by microwave irradiation in the preparation of polyesterols can lead to a considerable acceleration of reaction.

Moreover, the microwave radiation achieves a high efficiency. In contrast to conventional processes in which the heating is effected externally, the microwave radiation heats the reaction mixture directly, effectively “internally”. As a result, less energy is released to the environment; as a result, less energy is required for the same effect, and the efficiency is therefore higher.

The invention thus provides a process for preparing polyester alcohols by catalytically reacting at least one at least difunctional carboxylic acid or a derivative thereof with at least one at least difunctional alcohol, which comprises performing at least part of the reaction in the presence of microwave radiation.

The invention further provides the polyesterols preparable by the process according to the invention, and the use thereof for preparation of polyurethanes.

The present invention further provides for the use of microwave radiation in a process for preparing polyester alcohols.

In one embodiment, the catalytic reaction is performed in the presence of an esterification catalyst.

Preference is given to using an esterification catalyst selected from the group comprising toluenesulfonic acids and organometallic compounds. Especially preferred esterification catalysts are organometallic compounds based on titanium or tin.

Particular preference is given to organometallic compounds selected from the group comprising titanium tetrabutoxide, tin(II) octoate, dibutyltin laurate and tin chloride.

The at least difunctional alcohols used are preferably di- and/or trifunctional alcohols.

More particularly, the alcohols have 2 to 12 carbon atoms, preferably 2 to 6 carbon atoms, in the molecule. Examples of dihydric alcohols used with preference are ethanediol, diethylene glycol, 1,2- or 1,3-propanediol, dipropylene glycol, 1,4-butanediol, 1,5-pentanediol, 1,6-hexanediol, 1,10-decanediol.

In order to increase the functionality, it is also possible to use trihydric or higher polyhydric alcohols. Examples of trihydric or higher polyhydric alcohols used with preference are glycerol, trimethylolpropane, pentaerythritol, sorbitol and sucrose. It is also possible to use oligomeric or polymeric products with at least two hydroxyl groups. Examples thereof are polytetrahydrofuran, polylactones, polyglycerol, polyetherols, polyesterols or α,ω-dihydroxypolybutadiene.

The term “at least difunctional alcohol” in the context of the present disclosure is equivalent to the term “polyhydroxyl compound”.

In principle, it is also possible to use even higher-functionality alcohols; this leads, however, to very high-viscosity products and is therefore not preferred.

The carboxylic acids having at least two acid groups (at least difunctional carboxylic acids) used may preferably be aliphatic or aromatic dicarboxylic acids, especially those having 2 to 12 carbon atoms.

Examples of carboxylic acids usable in accordance with the invention are adipic acid, succinic acid, glutaric acid, suberic acid, azelaic acid, sebacic acid, decanedicarboxylic acid, maleic acid, fumaric acid, phthalic acid, isophthalic acid, terephthalic acid and isomeric naphthalenedicarboxylic acids, and the derivatives of the carboxylic acids mentioned, especially carboxylic esters and carboxylic anhydrides.

The carboxylic acids or derivatives thereof are preferably selected from the group comprising adipic acid, sebacic acid, phthalic acid, isophthalic acid and terephthalic acid.

Instead of the dicarboxylic acids, it is possible, as mentioned, also to use the corresponding dicarboxylic acid derivatives, for example dicarboxylic esters of alcohols having 1 to 6 carbon atoms or dicarboxylic anhydrides.

The dicarboxylic acids or derivatives thereof can be used either individually or in a mixture with one another. Preference is given to using dicarboxylic acid mixtures composed of succinic acid, glutaric acid and adipic acid in ratios of, for example, (20 to 35): (35 to 50): (20 to 32) parts by weight, mixtures of phthalic acid and/or phthalic anhydride and adipic acid, mixtures of phthalic acid and/or phthalic anhydride, isophthalic acid and adipic acid, or dicarboxylic acid mixtures of succinic acid, glutaric acid and adipic acid and mixtures of terephthalic acid and adipic acid, or dicarboxylic acid mixtures of succinic acid, glutaric acid and adipic acid. For use in rigid polyurethane foams, preference is given to using aromatic carboxylic acids or mixtures which comprise aromatic carboxylic acids.

To prepare the polyester polyols, the dicarboxylic acids and/or derivatives thereof and at least difunctional alcohols are polycondensed preferably in a molar ratio of 1:(1 to 2.1), preferably 1:(1.05 to 1.9). The functionality of the polyester alcohols prepared is, depending on the raw materials used, preferably in the range from at least 1.9 to 4.0, more preferably in the range from 2.0 to 3.0.

The number-average molecular weight of the polyester alcohols preparable in accordance with the invention is preferably in the range from 200 g/mol to 10000 g/mol, more preferably in the range of 500-5000 g/mol.

The at least one further polyhydroxyl compound, which is added in one embodiment of the process according to the invention, is preferably likewise selected from the above-described group of the at least difunctional alcohols.

The preparation of polyesterols requires energy to evaporate the water of condensation. The state of the art is to introduce this energy by conventional heating, i.e. by means of heat carrier and/or heat exchanger surfaces in the form of a heating jacket or internal heat exchangers.

Additional energy introduction by microwave irradiation in the course of preparation of polyesterols leads, as has now been found, to a shorter reaction time.

“Microwave radiation” means electromagnetic radiation in the frequency range from 300 MHz to 300 GHz (cf. Römpp Online Lexikon, Version 3.6, Georg Thieme Verlag 2010).

In one embodiment of the process according to the invention, 5 to 95% of the total energy required is supplied by irradiation with microwave radiation.

In a preferred embodiment of the invention, the irradiation is effected with an electromagnetic spectrum with a frequency of 2.45 GHz +/−10% or 915 MHz +/−10%.

In one embodiment of the process according to the invention, microwave irradiation is effected for 5% to 100% of the reaction time.

The irradiation can be effected directly within the reactor, through a microwave-transparent window, for example made of quartz or Teflon, or indirectly by circulation of the reactor contents through a space irradiated with microwaves.

In one embodiment of the process according to the invention, the catalytic reaction is performed in two stages and comprises the following process steps:
a) preparing at least one base polyester alcohol by the reaction of in each case at least one at least difunctional carboxylic acid or derivative thereof with in each case at least one polyhydroxyl compound, and
b) reacting the product from step a) or a mixture of the product from step a), optionally in a mixture with at least one further polyhydroxyl compound, for example other polyesterols, in the presence of microwave radiation.

In a preferred embodiment of the two-stage process mentioned, the base polyester alcohol according to step a) has a molecular weight of more than 1000 g/mol.

In a further embodiment of the two-stage process, step a) is performed in the presence of microwave radiation.

In a further embodiment of the two-stage process, step b) is performed in the presence of microwave radiation.

In a further embodiment of the two-stage process, the entire reaction is performed in the presence of microwave radiation.

In a further embodiment of the two-stage process, step b) is performed continuously.

As evident, the process according to the invention gives distinct advantages over the conventional processes: without a negative change in the quality of the polyol obtained and of the polyurethane prepared therefrom, the cycle time is shortened considerably. In addition, undesired decomposition and discoloration as a result of overheating owing to the conventional external heating of the reaction mixture can be avoided, since the energy in the case of use of microwaves is transferred directly to the reaction mixture as heat (internal heating).

The invention further relates to a suitable reactor for the performance of the process according to the invention for preparation of polyols, which reactor is at least partly heated by microwave irradiation.

The reactor may be configured in such a way that the product prepared is circulated through an external microwave-heated line.

The invention further relates to a process for preparing a polyurethane, especially a thermoplastic polyurethane, by reacting a polyester polyol prepared (or preparable) by the process according to the invention with one or more organic diisocyanates (or polyisocyanates).

The polyurethanes can be prepared by the known processes, batchwise or continuously, for example with reaction extruders or the “one-shot” belt process or the prepolymer process (including multistage prepolymer processes as in U.S. Pat. No. 6,790,916B2), preferably by the “one-shot” process. In these processes, the polyesterol, chain extender and isocyanate components being reacted, and optionally assistants and additives (especially UV stabilizers), can be mixed with one another successively or simultaneously, and the reaction sets in immediately.

A preferred field of use for the inventive polyester alcohols is, especially owing to the possibility of establishing a functionality of exactly 2, that of thermoplastic elastomers (TPU).

The thermoplastic elastomers are prepared by reacting diisocyanates with compounds having at least two hydrogen atoms reactive with isocyanate groups, preferably difunctional alcohols, more preferably with the polyesterols preparable in accordance with the invention.

The diisocyanates used are customary aromatic, aliphatic and/or cycloaliphatic diisocyanates, for example diphenylmethane diisocyanate (MDI), toluene diisocyanate (TDI), tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or −2,6-cyclohexane diisocyanate, 4,4′-, 2,4′- and/or 2,2′-dicyclohexylmethane diisocyanate.

The isocyanate-reactive compounds used are, as described, the inventive polyester alcohols. In a mixture with the latter, it is possible to use commonly known polyhydroxyl compounds with molecular weights of 500 to 8000, preferably 600 to 6000, especially 800 to 4000, and preferably a mean functionality from 1.8 to 2.6, preferably 1.9 to 2.2, especially 2, for example polyester alcohols, polyether alcohols and/or polycarbonate diols.

The isocyanate-reactive compounds also include the chain extenders. The chain extenders used may be commonly known, especially difunctional, compounds, for example diamines and/or alkanediols having 2 to 10 carbon atoms in the alkylene radical, especially ethylene glycol and/or butane-1,4-diol, and/or hexanediol and/or di- and/or trioxyalkylene glycols having 3 to 8 carbon atoms in the oxyalkylene radical, preferably corresponding oligo(polyoxypropylene glycols), and it is also possible to use mixtures of the chain extenders. The chain extenders used may also be 1,4-bis(hydroxymethyl)benzene (1,4-BHMB), 1,4-bis(hydroxyethyl)benzene (1,4-BHEB) or 1,4-bis(2-hydroxyethoxy)benzene (1,4-HQEE). Preferred chain extenders are ethylene glycol and hexanediol, particular preference being given to ethylene glycol.

Typically, catalysts which accelerate the reaction between the NCO groups of the diisocyanates and the hydroxyl groups of the structural components are used, for example tertiary amines such as triethylamine, dimethylcyclohexylamine, N-methylmorpholine, N,N′-dimethylpiperazine, 2-(dimethylaminoethoxy)ethanol, diazabicyclo[2.2.2] octane, and similar and especially organic metal compounds such as titanic esters, iron compounds, for example iron(III) acetylacetonate, tin compounds such as tin diacetate, tin dilaurate or the tin dialkyl salts of aliphatic carboxylic acids, such as dibutyltin diacetate, dibutyltin dilaurate or the like. The catalysts are typically used in amounts of 0.0001 to 0.1 part by weight per 100 parts by weight of polyhydroxyl compound.

As well as catalysts, customary assistants can also be added to the structural components. Examples include surfactants, flame retardants, nucleating agents, sliding and demolding aids, dyes and pigments, inhibitors, stabilizers against hydrolysis, light, heat, oxidation or discoloration, stabilizers against microbial degradation, inorganic and/or organic fillers, reinforcers and plasticizers.

Further details of the abovementioned assistants and additives can be found in the technical literature, for example in “Plastics Additive Handbook”, 5th Edition, H. Zweifel, ed, Hanser Publishers, Munich, 2001, H. Saunders and K. C. Frisch “High Polymers”, volume XVI, Polyurethane [Polyurethanes], parts 1 and 2, Verlag Interscience Publishers 1962 and 1964, Taschenbuch für Kunststoff-Additive by R. Gachter and H. Muller (Hanser Verlag Munich 1990) or DE-A 29 01 774.

Apparatus for preparation of polyurethanes is known to those skilled in the art; see, for example, Kunststoffhandbuch, volume VII, Polyurethane, Carl-Hanser-Verlag, Munich, 1st edition 1966, edited by Dr. R. Vieweg and Dr. A. Höchtlen, and also 2nd edition 1983 and the 3rd revised edition 1993, edited by Dr. G. Oertel.

The present invention relates to the use of a polyester polyol prepared by the process according to the invention for production of polyurethanes (also referred to hereinafter as PUR), especially of flexible PUR foam, rigid PUR foam, rigid polyisocyanurate (PIR) foam, cellular or noncellular PUR materials or polyurethane dispersions. The polyurethanes as described above can be used, inter alia, for production of mattresses, shoe soles, seals, pipes, floors, profiles, coating materials, adhesives, sealants, skis, car seats, running tracks in stadia, instrument panels, various moldings, potting compositions, films, fibers, nonwovens and/or cast floors.

The invention further relates to the use of the inventive polyester polyols for preparation of polyurethanes, for example for the preparation of (foamed) flexible foam or compact cast systems.

The present invention further relates to use of a thermoplastic polyurethane prepared by the process according to the invention for production of moldings, pipes, films and/or fibers.

The present invention further relates to a molding, a film, a pipe or a fiber, prepared from a thermoplastic polyurethane based on the process according to the invention.

### DRAWING

Drawing 1 shows a schematic of an illustrative structure of an apparatus in which the process according to the invention can be performed.

Key for drawing 1: M=Motor; TI=Temperature indicator; TI C=Temperature indicator control; R=Stirrer; Generator=Microwave generator

### EXAMPLE

Hereinafter, an example will be described to illustrate the invention. In no way shall this example restrict the scope of protection of the present invention; it should be understood merely as an illustration.

### Example 1

### Test Setup:

6.9 l jacketed metal reactor, column, distillation apparatus, cooler, thermocouple, nitrogen inlet, rotameter, MW generator with control system and regulator, HT thermostat with regulator (USH 400), data recorder (Budde-Graph). See also drawing 1.

Recipe: 3020.06 g of adipic acid
703.43 g of monoethylene glycol
1021.31 g of 1,4-butanediol
1 ppm of titanium tetrabutoxide (TTB) (1% in toluene)
5 ppm of tin octoate (SDO) (1% in toluene)

### Conditions:

Heating: 4.5 kW with oil thermostat and 0.8 kW with microwaves (frequency of 2.45 GHz)

### Nitrogen: 60 l/h

### Stirrer: Cross-beam

Speed: 150 rpm (revolutions per minute)

### Temperature: 240° C.

### Experimental Procedure:

The experiments were carried out in a 6.9 l metal reactor with a cross-beam stirrer at atmospheric pressure. The temperature was regulated using a high-temperature thermostat and using microwave irradiation.

For the standard reaction, the feedstocks (monoethylene glycol, 1,4-butanediol and adipic acid) were introduced into the cold reactor, inertized with N₂ and then heated to 110° C. Thereafter, the catalyst (TTB in toluene) was added via a septum. After the toluene had evaporated, the septum was exchanged for a metal stopper. Subsequently, the mixture was heated to 240° C. firstly under MW irradiation, and secondly for comparison in a further experiment with conventional operation. The temperature was controlled in such a way that the column top temperature never rose above 100° C. In the operation under MW irradiation, the condensation set in 40 minutes earlier than in the case of conventional operation. The theoretical amount of water expected had distilled off 60 minutes quicker. The reaction was stopped without vacuum operation; the progress of the reaction was monitored by determining the acid number and the OH number (table 1). Thereafter, the mixture was heated to 240° C. and left at this temperature under a reduced pressure of 40 mbar until an acid number less than 2 mg KOH/g had been attained.

TABLE 1
Result:

| | Duration | AN (acid number) | OHN (OH number) |
|---|---|---|---|
| Operation | [min] | [mg KOH/g] | [mg KOH/g] |
| Conventional | 206 | 55.48 | 92.36 |
| Under MW | 147 | 45.24 | 82.51 |
| irradiation | | | |

The advantage of microwave irradiation over the conventional operation is clear in the preparation of polyesterols. The condensation commences earlier and the distillative removal of the water of reaction is complete much earlier. The production cycle time was thus reduced.

1) A process for preparing polyester alcohols by catalytically reacting at least one at least difunctional carboxylic acid or a derivative thereof with at least one at least difunctional alcohol, which comprises performing at least part of the reaction in the presence of microwave radiation.

2) The process according to claim 1, wherein the catalytic reaction is performed in two stages and comprises the following process steps:
2a) preparing at least one base polyester alcohol by the reaction of in each case at least one at least difunctional carboxylic acid or derivative thereof with in each case at least one polyhydroxyl compound,
2b) reacting the product from step a) or a mixture of the product from step a), optionally in a mixture with at least one further polyhydroxyl compound, in the presence of microwave radiation.

3) The process according to claim 2, wherein the base polyester alcohol preparable in step 2a) has a molecular weight of more than 1000 g/mol.

4) The process according to claim 2 or 3, wherein step a) is performed in the presence of microwave radiation.

5) The process according to claim 2 or 3, wherein step b) is performed in the presence of microwave radiation.

6) The process according to claim 1, 2 or 3, wherein the entire reaction is performed in the presence of microwave radiation.

7) The process according to any of claims 2 to 6, wherein step b) is performed continuously.

8) The process according to any of the preceding claims, wherein the at least difunctional carboxylic acid or the derivative thereof is selected from the group comprising adipic acid, succinic acid, glutaric acid, suberic acid, azelaic acid, sebacic acid, decanedicarboxylic acid, maleic acid, fumaric acid, phthalic acid, isophthalic acid, terephthalic acid and isomeric naphthalenedicarboxylic acids, and comprising the derivatives of the carboxylic acids mentioned, especially carboxylic esters and carboxylic anhydrides.

9) The process according to any of the preceding claims, wherein the at least difunctional alcohol is selected from the group comprising di- and trifunctional alcohols, preferably having 2 to 12 carbon atoms, more preferably from the group comprising ethanediol, diethylene glycol, 1,2- or 1,3-propanediol, dipropylene glycol, 1,4-butanediol, 1,5-pentanediol, 1,6-hexanediol, 1,10-decanediol, glycerol and trimethylolpropane.

10) The process according to any of the preceding claims, wherein the catalyst is selected from the group of the esterification catalysts comprising toluenesulfonic acids and organometallic compounds.

11) The process according to any of claims 2 to 10, wherein the at least one further polyhydroxyl compound is selected from the group of the at least difunctional alcohols as described in claim 9.

12) The process according to any of the preceding claims, wherein the energy input of the microwave radiation is at least 5% and at most 95% of the total energy required.

13) The use of microwave radiation in a process for preparing polyester alcohols.

14) Polyesterol alcohols preparable according to any of claims 1 to 12.

15) The use of polyester alcohols according to claim 14 for preparation of polyurethanes.
